(19) United States
(12) Patent Application Publication
(10) Pub. No.: US 2005/0237023 A1
(43) Pub. Date: Oct. 27, 2005

(54) Power switch device

(75) Inventor: Heng Zhang, Dong-Guan (CN)

Correspondence Address: RADER FISHMAN & GRAUER PLLC, LION BUILDING, 1233 20TH STREET N.W., SUITE 501, WASHINGTON, DC, 20036, US

(73) Assignee: Asia Optical Co., Inc.

(21) Appl. No.: 11/030,207

(22) Filed: Jan. 7, 2005

(30) Foreign Application Priority Data
Apr. 22, 2004 (TW) 93111219

(51) Int. Cl. H02P 9/04

(52) U.S. Cl. 320/128

(57) ABSTRACT

The power switch device, including a controller, an undervoltage lockout circuit (UVLO) and an input voltage detection circuit, is configured to appropriately switch either a battery power or a public electricity to a portable electrical product. The power switch device further includes a thermal sense circuit, a current detection circuit and an output voltage detection circuit to provide over-high or over-low voltage protection, over-high current protection and over-high temperature protection.

### CROSS REFERENCE TO RELATED APPLICATIONS

This application claims priority to Taiwan Patent Application No. 093111219 entitled “Power Switch Device”, filed on Apr. 22, 2004.

### FIELD OF INVENTION

The present invention generally relates to a power switch device with power protection function.

### BACKGROUND OF THE INVENTION

With the progress of technology being well received by modern people, the portable electrical products (e.g., cell phone, PDA, digital camera, notebook computer, and so on) play important roles in people's life. In order to meet difference operation environments, these portable electrical products are usually designed to either use the battery power or the public electricity as their power sources. There is no problem for the portable electrical products when only one of the power sources exists. However, when both two power sources are connected to a portable electrical product, it is desirable to use a power switch device configured to appropriately switch between a battery power and public electricity to the portable electrical product.

FIG. 1 illustrates a prior art power switch device of a digital camera. The power switch device includes 2 input terminals and 2 output terminals. The 2 input terminals are respectively a battery power input terminal (VIN1) and a public electricity input terminal (VIN2). The 2 output terminals are respectively a power output terminal (VOUT) and a power status output terminal (AD). The transistor 101, which is generally the SI3493DC P-channel transistor produced by Vishay Siliconix, is the buffer stage of the battery power input terminal (VIN1). The transistor 103, used as a switch, is turned on as voltage of the public electricity input terminal (VIN2) is lower than voltage of the third pin of the transistor 101 (typically exceeding 0.7V). The transistor 101 is further turned on. Therefore, voltage of the battery power is transmitted to the power output terminal (VOUT) through the battery power input terminal (VIN1), and then is used by the portable electrical product.

When voltage of the public electricity input terminal (VIN2) rises, which means connecting to the public electricity, the transistor 103 is turned off and then the transistor 101 is further turned off. Therefore voltage of the battery power cannot be transmitted to the power output terminal (VOUT). After being processed by the elements 105, 107, to 119, voltage of the public electricity input terminal (VIN2) turns on the transistor 121, i.e. the output buffer stage, and then is transmitted to the power output terminal (VOUT). The SI3493DC P-channel transistor produced by Vishay Siliconix is also generally adopted as the transistor 121. The prior art power switch device achieves the power switching function by the methods described above.

Furthermore, the elements 123, 125, 127, 129 and 131, which are configured to process the signals from the public electricity input terminal (VIN2), are also included in the prior art power switch device. When the public electricity input terminal (VIN2) is high voltage level, the voltage level of the power status output terminal (AD) becomes low. On the contrary, when the public electricity input terminal (VIN2) is low voltage level, the voltage level of the power status output terminal (AD) becomes high. As a result, according to the voltage level of the power status output terminal (AD), one may determine if the input power is a batter power or a public electricity.

However, the prior art power switch device can only make switching according to the voltage level of the input terminal, and cannot further detect whether the input power is within a reasonable range. Consequently, the prior art power switch device can not protect the portable electrical product from over-high voltage (or current) which may damage the internal circuits, and from over-low voltage (or current) which may result in abnormal operation of the portable electrical product.

### SUMMARY OF THE INVENTION

The present invention provides a power switch device which is configured to receive both a battery power and a public electricity, and, more particularly, to appropriately switch either a battery power or a public electricity to an output terminal of the power switch device for the portable electrical products. The portable electrical products described herein may include cell phone, PDA, digital camera, notebook and so on. The present invention detects whether the input voltage is within a reasonable range, and furthermore protects the portable electrical products.

The power switch device includes a controller, a first undervoltage lockout circuit, and an input voltage detection circuit. The first undervoltage lockout circuit, which is connected to the battery power and the controller, is configured to detect whether voltage of the battery power is lower than a first predetermined value. The input voltage detection circuit, which is connected to the public electricity and the controller, is configured to detect whether voltage of the public electricity is within a first predetermined range. On the one hand, the controller switches the public electricity to the output terminal as voltage of the battery power is detected by the first undervoltage lockout circuit as being lower than the first predetermined value, and on the other hand, the controller switches the battery power to the output terminal as voltage of the public electricity is detected by the input voltage detection circuit as being not within the first predetermined range.

The power switch device further detects whether voltage of the battery power is higher than voltage of the public electricity as voltage of the battery power is detected by the first undervoltage lockout circuit as being not lower than the first predetermined value. If voltage of the battery power is not higher than voltage of the public electricity, the controller switches the public electricity to the output terminal.

The power switch device further detects whether voltage of the public electricity is higher than voltage of the battery power as voltage of the public electricity is detected by the input voltage detection circuit as being within the first predetermined range. If voltage of the public electricity is not higher than voltage of the battery power, the controller switches the battery power to the output terminal.

The described input voltage detection circuit further includes a second undervoltage lockout circuit and a comparator. The second undervoltage lockout circuit, which is connected to the public electricity and the controller, is configured to detect whether voltage of the public electricity is lower than a second predetermined value. The comparator, which is also connected to the public electricity and the controller, is configured to detect whether voltage of the public electricity is higher than a third predetermined value. The first predetermined range as described above is defined by the second predetermined value and the third predetermined value.

In addition to the described function, the power switch device further includes several protection circuits, such as thermal sense circuit, current detection circuit and output voltage detection circuit and the like. The thermal sense circuit is configured to sense temperature of the power switch device. The output terminal is no connection as temperature of the power switch device is higher than a fourth predetermined value. The current detection circuit is configured to detect current of the output terminal. The output terminal is no connection as current of the output terminal is higher than a fifth predetermined value. The output voltage detection circuit is configured to detect voltage of the output terminal. The output terminal is no connection as voltage of the output terminal is not within a second predetermined range.

Consequently, the power switch device of the present invention includes at least the following advantages: detection and appropriate switching of the input powers, over-high or under-low voltage protection, over-high current protection and over-high temperature protection.

### BRIEF DESCRIPTION OF THE DRAWINGS

FIG. 1 illustrates a prior art power switch device; and

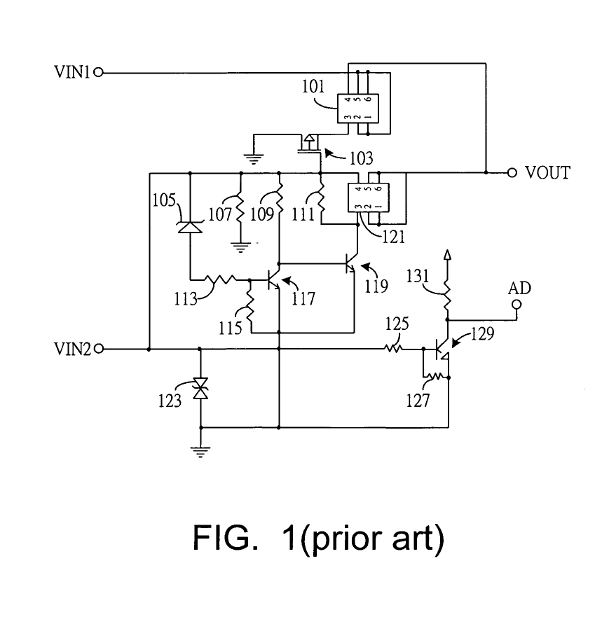

FIG. 2 illustrates a power switch device of the present invention;

### DETAILED DESCRIPTION OF THE INVENTION

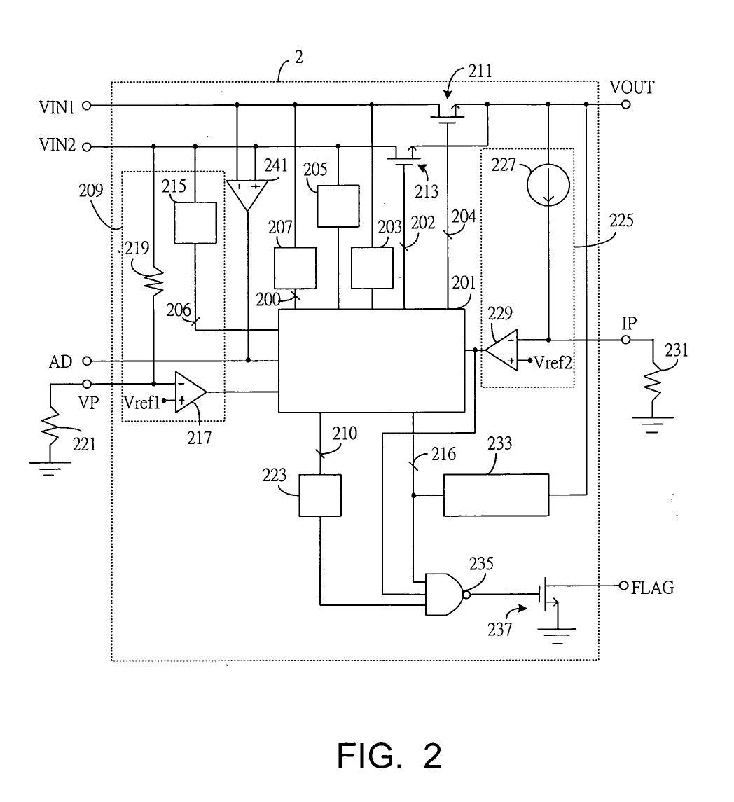

In one embodiment of the present invention, with reference to FIG. 2, a power switch device 2 includes 5 input terminals and 3 output terminals. The 5 input terminals include a battery power input terminal (VIN1), a public electricity input terminal (VIN2), an over-voltage protection-setting terminal (VP), an over-current protection-setting terminal (IP), and a ground terminal (not illustrated in FIG. 2). The 3 output terminals include a power output terminal (VOUT), an abnormal status output terminal (FLAG), and a power status output terminal (AD). The battery power input terminal (VIN1) and the public electricity input terminal (VIN2) are respectively connected to a battery power and a public electricity. It should be noted that voltage of the public electricity, which is transmitted from the power company, is transformed and rectified appropriately by a pre-stage circuit before being transmitted to the public electricity input terminal (VIN2). The over-voltage protection-setting terminal (VP) sets a voltage threshold value to detect whether the input voltage of the public electricity is over-high, and the over-current protection-setting terminal (IP) sets a current threshold value to detect whether the output current of the power output terminal (VOUT) is over-high. The power output terminal (VOUT), which is connected to a portable electrical product, is configured to output a selected power for the portable electrical product. The abnormal status output terminal (FLAG) is configured to output a signal which may notify the portable electrical device and the user of the abnormality of the power switch device 2. The power status output terminal (AD) is configured to output a signal which may tell the portable electrical device and the user about the type of the output power of the power switch device 2 being switched.

The power switch device 2 further includes a controller 201, a first interior voltage source 203, a second interior voltage source 205, a first undervoltage lockout circuit 207 and an input voltage detection circuit 209. The controller 201 is configured to receive the signals from other circuits, and then determine the output signal of the power output terminal (VOUT) by processing and detecting these signals. The single chip MC8051 may be a good choice for the controller 201. The first interior voltage source 203 and the second interior voltage source 205, which are respectively connect to the battery power input terminal (VIN1) and the public electricity input terminal (VIN2), are configured to provide power for the controller 201 to make sure that the controller 201 works normally as only one power source is available.

The first undervoltage lockout circuit 207, which may be any one of the well-known undervoltage lockout circuits, is connected to the battery power input terminal (VIN1) and the controller 201 and is configured to detect whether voltage of the battery power is lower than a first predetermined value. Voltage of the battery power is too low to supply a portable electrical product when it is lower than the first predetermined value (3V in this embodiment). In such situation, the first undervoltage lockout circuit 207 transmits a signal 200 to the controller 201, and therefore the controller 201 switches voltage of the public electricity to the power output terminal (VOUT).

The input voltage detection circuit 209, which is connected to the public electricity input terminal (VIN2) and the controller 201, is configured to detect whether voltage of the public electricity is within a first predetermined range (3˜5V in this embodiment). Voltage of the public electricity is too low or too high to be the power to a portable electrical product when it is not within the first predetermined range. In such situation, the controller 201 switches voltage of the battery power to the power output terminal (VOUT) after receiving the signal from the input voltage detection circuit 209. This part will be described in detail.

The power switch device 2 further includes a comparator 241, which may be the common operation amplifier (OPA) and is configured to compare voltage of the battery power and the public electricity and then output a signal to the controller 201 and the power status output terminal (AD). In this embodiment, the comparator 241 further detects whether voltage of the battery power is higher than voltage of the public electricity as voltage of the battery power is detected by the first undervoltage lockout circuit 207 as being not lower than the first predetermined value. In case voltage of the battery power is higher than voltage of the public electricity, which represents that voltage of the battery power is more suitable for the portable electrical product, the comparator 241 outputs a low-level signal. After receiving the signal from the comparator 241, the controller 201 switches the battery power to the power output terminal (VOUT). In case voltage of the battery power is not higher than voltage of the public electricity, which represents that voltage of the public electricity is more suitable for the portable electrical product, the comparator 241 outputs a high-level signal. After receiving the signal from the comparator 241, the controller 201 switches the public electricity to the power output terminal (VOUT).

Similarly, the comparator 241 further detects whether voltage of the public electricity is higher than voltage of the battery power as voltage of the public electricity is detected by the input voltage detection circuit 209 as being within the first predetermined range. In case voltage of the public electricity is higher than voltage of the battery power, which represents that voltage of the public electricity is more suitable for the portable electrical product, the comparator 241 outputs a high-level signal. After receiving the signal from the comparator 241, the controller 201 switches the public electricity to the power output terminal (VOUT). In case voltage of the public electricity is not higher than voltage of the battery power, which represents that voltage of the battery power is more suitable for the portable electrical product, the comparator 241 outputs a low-level signal. After receiving the signal from the comparator 241, the controller 201 switches the battery power to the power output terminal (VOUT).

The transistors 211 and 213 function as the switches when the controller 201 described above switches signals. When the controller 201 switches the battery power to the power output terminal (VOUT), the output signal 204 is pulled high to turn on the transistor 211, and the output signal 202 is pulled low to turn off the transistor 213. Therefore voltage of the battery power is transmitted to the power output terminal (VOUT). On the contrary, when the controller 201 switches the public electricity to the power output terminal (VOUT), the output signal 204 is pulled low to turn off the transistor 211, and the output signal 202 is pulled high to turn on the transistor 213. Therefore voltage of the public electricity is transmitted to the power output terminal (VOUT).

The input voltage detection circuit 209 includes a second undervoltage lockout circuit 215, a comparator 217 and a resistor 219. The second undervoltage lockout circuit 215, which has the same structure as the first undervoltage lockout circuit 207, is configured to detect whether voltage of the public electricity is lower than a second predetermined value (3V in this embodiment). Furthermore, the second undervoltage lockout circuit 215 outputs a signal 206 to the controller 201 to switch the battery power to the power output terminal (VOUT) as voltage of the public electricity is lower than the second predetermined value. The comparator 217 and the resistor 219 are configured to detect whether voltage of the public electricity is higher than a third predetermined value (5V in this embodiment). The non-inverting input terminal of the comparator 217 is configured to connect a first internal reference voltage Vref1, and the inverting input terminal is configured to connected the resistor 219 and the over-voltage protection-setting terminal (VP). The first internal reference voltage Vref1, which is generated from another circuit (not shown), is configured to compare with the public electricity and is generally as low as possible for saving power. During the operation of the power switch device 2, the over-voltage protection-setting terminal (VP) needs to connect to a resistor 221 functioning as a voltage divider, and therefore voltage of the inverting input terminal of the comparator 217 is:

$$\frac{{R}_{221}}{{R}_{219} + {R}_{221}} \times VIN2$$

Where R₂₁₉ is resistance of the resistor 219 and R₂₂₁ is resistance of the resistor R221. Accordingly, voltage of the public electricity may indirectly compare with the first internal reference voltage Vref1 to detect whether voltage of the public electricity is higher than the third predetermined value. For example, if the third predetermined value is 5V, the first internal reference voltage Vref1 is 1V, and R₂₁₉ is 100KΩ, according to the above formula, R221 must be 25KΩ.

As described above, the first predetermined range (3V˜5V) is defined by the second predetermined value (3V) and the third predetermined value (5V).

The power switch device 2 further includes a thermal sense circuit 223 which is configured to sense temperature of the power switch device 2. When temperature of the power switch device 2 exceeds a fourth predetermined value, e.g. 150° C. the thermal sense circuit 223 outputs a signal 210 to the controller 201 and subsequently the controller 201 sets both the signal 202 and the signal 204 low to shut off the transistor 211 and transistor 213. The power output terminal (VOUT) is therefore no connection to avoid damaging the elements of the portable electrical product during the abnormal operation of the power switch device 2.

The power switch device 2 further includes a current detection circuit 225. The current detection circuit 225, which is connected to the power output terminal (VOUT), the controller 201 and the over-current protection-setting terminal (IP), is configured to detect whether current of the power output terminal (VOUT) is higher than a fifth predetermined value. When the output current is higher than the fifth predetermined value, it will damage the elements of the portable electrical product. The current detection circuit 225 includes a comparator 229 and a current extraction circuit 227 which extracts a specific ratio of the output current for comparison. The non-inverting input terminal is connected to a second internal reference voltage Vref2 and the inverting input terminal is connected to the over-current protection-setting terminal (IP). The second internal reference voltage Vref2, which is generated by another circuit (not shown) and is generally as low as possible for saving power, is a reference value for comparison. During the operation of the power switch device 2, a resistor 231 needs to connect to the over-current protection-setting terminal (IP). A voltage level is generated in the inverting terminal of the comparator 229 when the current extracted by the current extraction circuit 227 flows through the resistor 231. This voltage level is then compared with the second internal reference voltage Verf2. If current of the power output terminal (VOUT) is higher than the fifth predetermined value, the voltage level as described above will be higher than the second internal reference voltage Verf2 and therefore the comparator 229 outputs a low-level signal. Furthermore, the controller 201 sets the signal 202 and 204 low to shut off the transistor 211 and 213. The power output terminal is therefore no connection to avoid damaging the elements of the portable electrical product under the over-high output current situation.

The power switch device 2 further includes an output voltage detection circuit 233. The output voltage detection circuit 233, which is connected to the power output terminal VOUT and the controller 201, is configured to detect whether voltage of the power output terminal (VOUT) is within a second predetermined range (3V˜5V). When voltage of the power output terminal (VOUT) is not within the second predetermined range, which means over-high or over-low output voltage, the output voltage detection circuit 233 transmits a signal 216 to the controller 201 and then the controller 201 further sets both the signal 202 and 204 low to shut off the transistor 211 and transistor 213. The power output terminal is therefore no connection to avoid damaging the elements of the portable electrical product in the over-high or over-low output voltage situation.

The power switch device 2 further includes a transistor 237 and a NAND gate 235. The three input terminals of the NAND gate 235 are connected to the output terminals of the thermal sense circuit 223, the comparator 229 and the output voltage detection circuit 233. When one or more of the output terminals of the thermal sense circuit 223, the comparator 229 and the output voltage detection circuit 233 is pulled low, i.e. in abnormal situation, the output terminal of the NAND gate 235 is pulled high. Consequently, the transistor 237 is turned on and then the abnormal status output terminal (FLAG) is set to be low to inform the portable electrical product and the user of the abnormality of the power switch device 2. It should be noted that a pull-up resistor (not shown) has to connect to the abnormal status output terminal (FLAG) during the operation of the power switch device 2.

As above described, the present invention not only has the switching function, but also protects the portable electrical products from damage in abnormal situation.

Although the specific embodiments of the present invention have been illustrated and described, it is to be understood that the invention is not limited to those embodiments. One skilled in the art may make various modifications without departing from the scope or spirit of the invention.

1. A power switch device configured to appropriately switch either a battery power or a public electricity to an output terminal of said power switch device, said power switch device comprising:
a controller;
a first undervoltage lockout circuit configured to detect whether voltage of said battery power is under a first predetermined value; and
an input voltage detection circuit configured to detect whether voltage of said public electricity is within a first predetermined range;
wherein said controller switches said public electricity to said output terminal as voltage of said battery power is detected by said first undervoltage lockout circuit as being lower than said first predetermined value, said controller switches said battery power to said output terminal as voltage of said public electricity is detected by said input voltage detection circuit as being not within said first predetermined range.

2. The power switch device of claim 1, wherein said power switch device further detects whether voltage of said battery power is higher than voltage of said public electricity as voltage of said battery power is detected as being not lower than said first predetermined value, wherein said controller switches said public electricity to said output terminal as voltage of said battery power is not higher than voltage of said public electricity.

3. The power switch device of claim 1, wherein said power switch device further detects whether voltage of said public electricity is higher than voltage of said battery power as voltage of said public electricity is detected as being within said first predetermined range, wherein said controller switches said battery power to said output terminal as voltage of said public electricity is not higher than voltage of said battery power.

4. The power switch device of claim 1, wherein said input voltage detection circuit comprises:
a second undervoltage lockout circuit configured to detect whether voltage of said public electricity is lower than a second predetermined value; and
a comparator configured to detect whether voltage of said public electricity is higher than a third predetermined value;
wherein said first predetermined range is defined by said second predetermined value and said third predetermined value.

5. The power switch device of claim 1, further comprising a thermal sense circuit to sense temperature of said power switch device, wherein said output terminal is no connection as temperature of said power switch device is higher than a fourth predetermined value.

6. The power switch device of claim 1, further comprising a current detection circuit to detect current of said output terminal, wherein said output terminal is no connection as current of said output terminal is higher than a fifth predetermined value.

7. The power switch device of claim 1, further comprising an output voltage detection circuit to detect voltage of said output terminal, wherein said output terminal is no connection as voltage of said output terminal is not within a second predetermined range.

8. The power switch device of claim 1, wherein said output terminal is connected to a digital camera.

9. A power switch device configured to appropriately switch either a battery power or a public electricity to an output terminal of said power switch device, said power switch device comprising:
a controller;
a first undervoltage lockout circuit configured to detect whether voltage oF said battery power is lower than a first predetermined value; and
an input voltage detection circuit configured to detect whether voltage of said public electricity is within a first predetermined range, said input voltage detection circuit comprising:
a second undervoltage lockout circuit configured to detect whether voltage of said public electricity is lower than a second predetermined value; and
a comparator configured to detect whether voltage of said public electricity is higher than a third predetermined value, wherein said first predetermined range is defined by said second predetermined value and said third predetermined value;
wherein said controller switches said public electricity to said output terminal as voltage of said battery power is detected by said first undervoltage lockout circuit as being lower than said first predetermined value, said controller switches said battery power to said output terminal as voltage of said public electricity is detected by said input voltage detection circuit as being not within said first predetermined range.

10. The power switch device of claim 9, wherein said power switch device further detects whether voltage of said battery power is higher than voltage of said public electricity as voltage of said battery power is detected as being not lower than said first predetermined value, wherein said controller switches said public electricity to said output terminal as voltage of said battery power is not higher than voltage of said public electricity.

11. The power switch device of claim 9, wherein said power switch device further detects whether voltage of said public electricity is higher than voltage of said battery power as voltage of said public electricity is detected as being within said first predetermined range, wherein said controller switches said battery power to said output terminal as voltage of said public electricity is not higher than voltage of said battery power.

12. The power switch device of claim 9, further comprising a thermal sense circuit to sense temperature of said power switch device, wherein said output terminal is no connection as temperature of said power switch device is higher than a fourth predetermined value.

13. The power switch device of claim 9, further comprising a current detection circuit to detect current of said output terminal, wherein said output terminal is no connection as current of said output terminal is higher than a fifth predetermined value.

14. The power switch device of claim 9, further comprising an output voltage detection circuit to detect voltage of said output terminal, wherein said output terminal is no connection as voltage of said output terminal is within a second predetermined range.

15. The power switch device of claim 9, wherein said output terminal is connected to a digital camera.

16. A power switch and protection device configured to appropriately switch either a battery power or a public electricity, and configured to avoid abnormal output of said power switch and protection device, said power switch and protection device comprising:
an output terminal;
an abnormal output terminal;
a controller;
a first undervoltage lockout circuit to detect whether voltage of said battery power is lower than a first predetermined value, wherein said controller switches said public electricity to said output terminal as voltage of said battery power is lower than said first predetermined value;
an input voltage detection circuit to detect whether voltage of said public electricity is within a first predetermined range, wherein said controller switches said battery power to said output terminal as voltage of said public electricity is not within the first predetermined range, said input voltage detection circuit comprising:
a second undervoltage lockout circuit configured to detect whether voltage of said public electricity is lower than a second predetermined value; and
a comparator configured to detect whether voltage of said public electricity is higher than a third predetermined value; wherein said first predetermined range is defined by said second predetermined value and said third predetermined value;
a thermal sense circuit to sense temperature of said power switch and protection device, wherein said output terminal is no connection and said abnormal output terminal outputs an abnormal value as temperature of said power switch and protection device is higher than a fourth predetermined value;
a current detection circuit to detect current of said output terminal, wherein said output terminal is no connection and said abnormal output terminal outputs an abnormal value as current of said output terminal is higher than a fifth predetermined value; and
an output voltage detection circuit to detect voltage of said output terminal, wherein said output terminal is no connection and said abnormal output terminal outputs an abnormal value as voltage of said output terminal is not within a second predetermined range.

17. The power switch and protection device of claim 16, wherein said power switch and protection device further detects whether voltage of said battery power is higher than voltage of said public electricity as voltage of said battery power is detected as being not lower than said first predetermined value; wherein said controller switches said public electricity to said output terminal as voltage of said battery power is not higher than voltage of said public electricity.

18. The power switch and protection device of claim 16, wherein said power switch and protection device further detects whether voltage of said public electricity is higher than voltage of said battery power as voltage of said public electricity is detected as being within said first predetermined range, wherein said controller switches said battery power to said output terminal as voltage of said public electricity is not higher than voltage of said battery power.

19. The power switch and protection device of claim 16, wherein said output terminal is connected to a digital camera.
